(19) United States
(12) Patent Application Publication
(10) Pub. No.: US 2025/0336604 A1
(43) Pub. Date: Oct. 30, 2025

(54) MULTILAYER CERAMIC CAPACITOR

(71) Applicant: Murata Manufacturing Co., Ltd., Nagaokakyo-shi (JP)

(72) Inventors: Kenichi BANDO, Nagaokakyo-shi (JP); Toshihiko KOBAYASHI, Nagaokakyo-shi (JP)

(21) Appl. No.: 19/260,776

(22) Filed: Jul. 7, 2025

Related U.S. Application Data
(63) Continuation of application No. PCT/JP2024/017924, filed on May 15, 2024.

(30) Foreign Application Priority Data
Jul. 5, 2023 (JP) 2023-111030

(51) Int. Cl. H01G 4/232; H01G 4/12; H01G 4/248; H01G 4/30

(52) U.S. Cl. CPC H01G 4/2325; H01G 4/1209; H01G 4/248; H01G 4/30

(57) ABSTRACT

In a multilayer ceramic capacitor, an outer electrode film includes a first glass including a barium-boron-silicon-based glass, a strontium-boron-silicon-based glass, or a barium-strontium-boron-silicon-based glass, and a second glass including a bismuth-based glass. The first and second glass define glass domains in the outer electrode film. A glass domain exposed on a surface of the outer electrode film is defined as a first glass domain, and a glass domain exposed on an interface of the outer electrode film with the ceramic body is defined as a second glass domain. A concentration ratio of bismuth to silicon is larger in the first glass domain than in the second glass domain.

### CROSS REFERENCE TO RELATED APPLICATIONS

This application claims the benefit of priority to Japanese Patent Application No. 2023-111030 filed on Jul. 5, 2023 and is a Continuation Application of PCT Application No. PCT/JP2024/017924 filed on May 15, 2024. The entire contents of each application are hereby incorporated herein by reference.

### BACKGROUND OF THE INVENTION

### 1. Field of the Invention

The present invention relates to multilayer ceramic capacitors.

### 2. Description of the Related Art

One of methods for manufacturing terminal electrodes of multilayer ceramic capacitors involves applying, to a ceramic body, a conductive paste prepared by dispersing a conductive powder, such as copper powder, and a glass frit powder in a vehicle, drying the conductive paste, and firing it at a high temperature to form terminal electrodes electrically connected to inner electrode layers. Japanese Patent No. 6354970 discloses a method using a glass frit powder including barium.

Barium-boron-silicon-based glass can have a lower softening point than boron-silicon-based glass because of the inclusion of barium. A lower softening point allows for the formation of denser films.

Barium-boron-silicon-based glass is less likely to form a reaction layer at the interface with a ceramic body. Specifically, when the ceramic body includes barium, barium-boron-silicon-based glass prevents or reduces the migration of barium from the ceramic body because of barium includes in the glass, so that a reaction layer is difficult to form. Therefore, barium-boron-silicon-based glass can adhere well to the ceramic body.

Barium-boron-silicon-based glass, however, has low moisture resistance and may deteriorate or dissolve when exposed to an acidic plating solution. When the glass deteriorates, the plating solution may penetrate into terminal electrodes. The penetration of the plating solution into the terminal electrodes may cause reflow defects. It may also reduce the moisture resistance of the terminal electrodes and impair the reliability of the multilayer ceramic capacitor.

The problems associated with using barium-boron-silicon-based glass are described above, but similar problems arise when using strontium-boron-silicon-based glass and barium-strontium-boron-silicon-based glass.

### SUMMARY OF THE INVENTION

Example embodiments of the present invention provide multilayer ceramic capacitors each including a terminal electrode with moisture resistance while maintaining good adhesion between the terminal electrode and a ceramic body.

A multilayer ceramic capacitor according to an example embodiment of the present invention includes a ceramic body including a plurality of stacked dielectric layers and a plurality of stacked inner electrode layers, a first main surface and a second main surface facing each other in a height direction, a first side surface and a second side surface facing each other in a width direction perpendicular or substantially perpendicular to the height direction, and a first end surface and a second end surface facing each other in a length direction perpendicular or substantially perpendicular to the height direction and the width direction. and a terminal electrode on the ceramic body and connected to some of the inner electrode layers, wherein the terminal electrode includes an outer electrode film in contact with the ceramic body, the outer electrode film includes at least a first glass including at least one of a barium-boron-silicon-based glass, a strontium-boron-silicon-based glass, or a barium-strontium-boron-silicon-based glass, and a second glass including a bismuth-based glass, the first glass and the second glass define glass domains in the outer electrode film, and when, of the glass domains, a glass domain exposed on a surface of the outer electrode film but not exposed on an interface of the outer electrode film with the ceramic body is defined as a first glass domain, and a glass domain not exposed on the surface of the outer electrode film but exposed on the interface of the outer electrode film with the ceramic body is defined as a second glass domain, a concentration ratio of bismuth to silicon is higher in a portion of the first glass domain that is exposed on the surface of the outer electrode film than in a portion of the second glass domain that is exposed on the interface of the outer electrode film with the ceramic body.

Example embodiments of the present invention provide multilayer ceramic capacitors each including a terminal electrode with moisture resistance while maintaining good adhesion between the terminal electrode and a ceramic body.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view of a multilayer ceramic capacitor according to an example embodiment of the present invention.

FIG. 2 is a cross-sectional view taken along line I-I of FIG. 1.

FIG. 3 is a cross-sectional view taken along line II-II of FIG. 1.

FIG. 4 is an LT cross-sectional view of a second end surface and a surrounding area of a multilayer ceramic capacitor according to an example embodiment of the present invention.

FIG. 5 is a scanning electron microscope image of an outer electrode film according to an example embodiment of the present invention.

FIG. 6 is a scanning electron microscope image of another outer electrode film according to an example embodiment of the present invention.

FIG. 7 illustrates a method for evaluating adhesion performance according to an example embodiment of the present invention.

### DETAILED DESCRIPTION OF THE EXAMPLE EMBODIMENTS

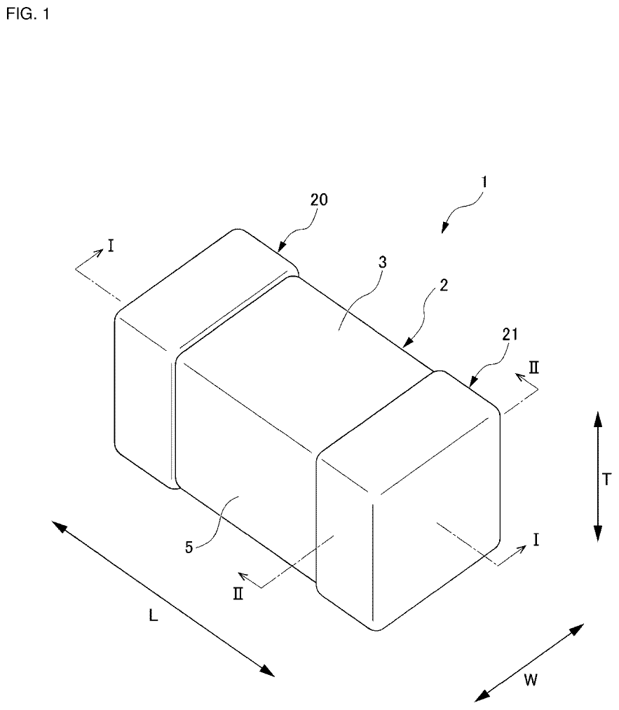

Example embodiments of the present invention will be described in detail below with reference to FIG. 1. FIG. 1 is a perspective view of a multilayer ceramic capacitor 1 according to an example embodiment of the present invention. FIG. 1 illustrates a two-terminal multilayer ceramic capacitor. The multilayer ceramic capacitor 1 is not limited to a two-terminal multilayer ceramic capacitor. The multilayer ceramic capacitor 1 may be a multiterminal multilayer ceramic capacitor, such as a three-terminal multilayer ceramic capacitor, for example.

The multilayer ceramic capacitor 1 includes a ceramic body 2 and terminal electrodes. The terminal electrodes include a first terminal electrode 20 and a second terminal electrode 21.

The ceramic body 2 includes multiple dielectric layers and multiple inner electrode layers stacked on top of one another. The ceramic body 2 has a rectangular or substantially rectangular parallelepiped shape.

The direction in which the dielectric layers and the inner electrode layers are stacked on top of one another in the ceramic body 2 is the height direction T. The direction perpendicular or substantially perpendicular to the height direction T is the width direction W. The direction perpendicular or substantially perpendicular to the height direction T and the width direction W is the length direction L.

One of the two surfaces of the ceramic body 2 facing each other in the height direction T is a first main surface 3. The other one of the two surface is a second main surface 4. One of the two surfaces of the ceramic body 2 facing each other in the width direction W is a first side surface 5. The other one of the two surface is a second side surface 6. One of the two surfaces of the ceramic body 2 facing each other in the length direction L is a first end surface 7. The other one of the two surface is a second end surface 8.

The cross-section of the ceramic body 2 taken along line I-I of FIG. 1 is referred to as an LT cross-section. The cross-section of the ceramic body 2 taken along line II-II of FIG. 1 is referred to as a WT cross-section.

The intersection of three surfaces of the ceramic body 2 is referred to as a corner of the ceramic body 2. The intersection of two surfaces of the ceramic body 2 is referred to as an edge of the ceramic body 2. The corners and edges are preferably rounded.

The total number of the dielectric layers stacked in the ceramic body 2 is, for example, preferably 15 or more and 2,000 or less. The main material of the dielectric layers is a ceramic material. The ceramic material is, for example, a dielectric ceramic including, as a main component, barium titanate, calcium titanate, strontium calcium zirconate, or other titanate, components. The ceramic material may be a dielectric ceramic including, in addition to the main component, a secondary component, such as a manganese compound, an iron compound, a chromium compound, a cobalt compound, or a nickel compound.

The thickness of one dielectric layer is, for example, preferably about 0.3 μm or more and about 10 μm or less.

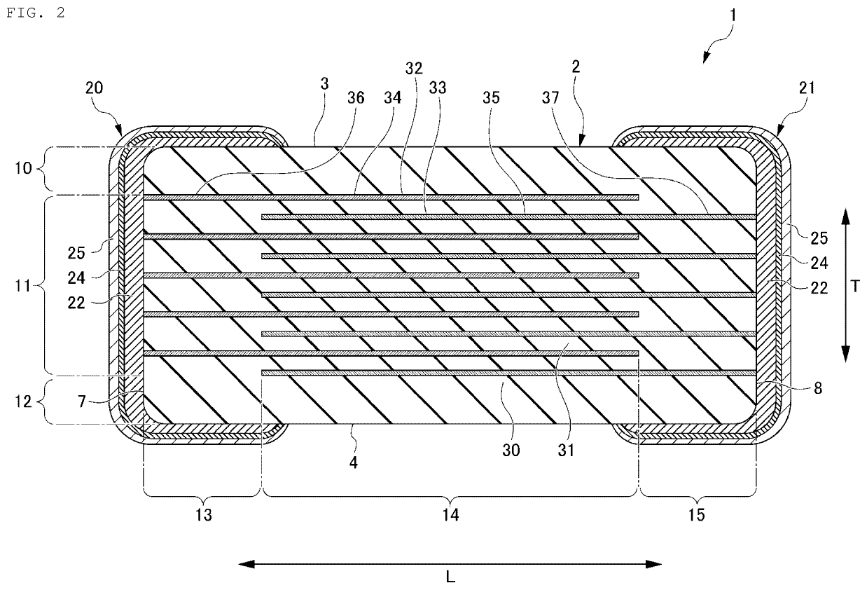

The segments of the ceramic body 2 in the length direction L will be described with reference to FIG. 2. FIG. 2 is a cross-sectional view taken along line I-I of FIG. 1. The ceramic body 2 can be divided into a first main surface-side outer layer portion 10, an active portion 11, and a second main surface-side outer layer portion 12 in the height direction T.

The first main surface-side outer layer portion 10 is a portion between the first main surface 3 and the inner electrode layer closest to the first main surface 3. The active portion 11 is a portion where the inner electrode layers face one another. The second main surface-side outer layer portion 12 is a portion between the second main surface 4 and the inner electrode layer closest to the second main surface 4.

Of the dielectric layers, the dielectric layers disposed in the first main surface-side outer layer portion 10 and the second main surface-side outer layer portion 12 are referred to as outer dielectric layers 30. Of the dielectric layers, the dielectric layers disposed in the active portion 11 are referred to as inner dielectric layers 31.

The ceramic body 2 may have any size. The dimension of the ceramic body 2 in the length direction L is, for example, preferably about 0.2 mm or more and about 10 mm or less. The dimension of the ceramic body 2 in the width direction W is, for example, preferably about 0.1 mm or more and about 5 mm or less. The dimension of the ceramic body 2 in the height direction T is, for example, preferably about 0.1 mm or more and about 5 mm or less.

The segments of the ceramic body 2 in the length direction L will be described. The ceramic body 2 can be divided into a first end surface-side outer layer portion 13, a length direction counter portion 14, and a second end surface-side outer layer portion 15 in the length direction L.

The length direction counter portion 14 is a portion where the inner electrode layers face one another in the height direction T. The first end surface-side outer layer portion 13 is a portion between the length direction counter portion 14 and the first end surface 7. The second end surface-side outer layer portion 15 is a portion between the length direction counter portion 14 and the second end surface 8.

The length direction counter portion 14 is a portion corresponding to the counter electrode portions of the inner electrode layers. The first end surface-side outer layer portion 13 and the second end surface-side outer layer portion 15 are portions corresponding to the extended electrode portions of the inner electrode layers. The first end surface-side outer layer portion 13 and the second end surface-side outer layer portion 15 are also referred to as L gaps.

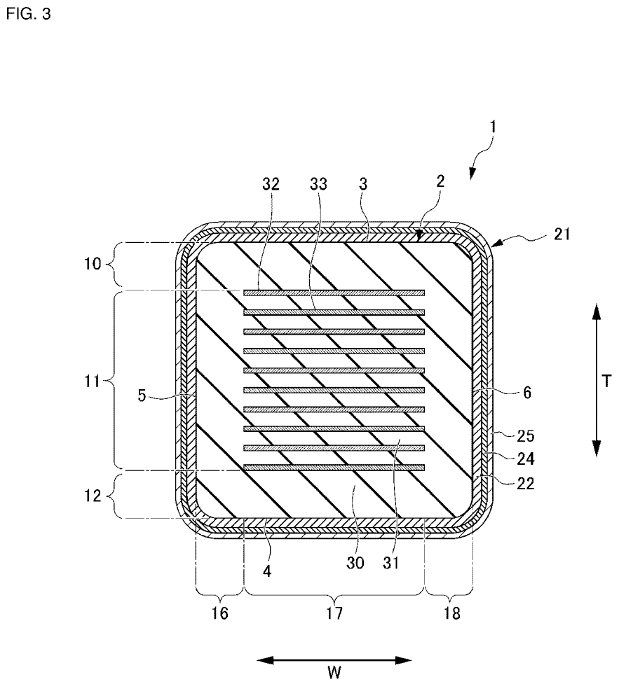

The segments of the ceramic body 2 in the width direction W will be described with reference to FIG. 3. FIG. 3 is a cross-sectional view taken along line II-II of FIG. 1. The ceramic body 2 can be divided into a first side surface-side outer layer portion 16, a width direction counter portion 17, and a second side surface-side outer layer portion 18 in the width direction W.

The width direction counter portion 17 is a portion where the inner electrode layers face one another in the height direction T. The first side surface-side outer layer portion 16 is a portion between the width direction counter portion 17 and the first side surface 5. The second side surface-side outer layer portion 18 is a portion between the width direction counter portion 17 and the second side surface 6.

The first side surface-side outer layer portion 16 and the second side surface-side outer layer portion 18 are portions where no inner electrode layers are provided in the height direction T. The first side surface-side outer layer portion 16 and the second side surface-side outer layer portion 18 are also referred to as W gaps.

The inner electrode layers include multiple first inner electrode layers 32 and multiple second inner electrode layers 33. The first inner electrode layers 32 are inner electrode layers exposed on the first end surface 7. The second inner electrode layers 33 are inner electrode layers exposed on the second end surface 8.

Each first inner electrode layer 32 can be divided into a first counter electrode portion 34 and a first extended electrode portion 36. The first counter electrode portions 34 face the second inner electrode layers 33. Each first extended electrode portion 36 extends from the corresponding first counter electrode portion 34 to the first end surface 7 of the ceramic body 2.

Each second inner electrode layer 33 can be divided into a second counter electrode portion 35 and a second extended electrode portion 37. The second counter electrode portions 35 face the first inner electrode layers 32. Each second extended electrode portion 37 extends from the corresponding second counter electrode portion 35 to the second end surface 8 of the ceramic body 2.

The material of the inner electrode layers may be, for example, a metal, such as nickel, copper, silver, palladium, or gold. The material of the inner electrode layers may be an alloy including at least one of the metals described above, such as a silver-palladium alloy, for example.

In the multilayer ceramic capacitor 1, the first counter electrode portions 34 alternate with the second counter electrode portions 35 with a corresponding one of the inner dielectric layers 31 interposed therebetween to generate capacitance. With such a configuration, the multilayer ceramic capacitor 1 provides the characteristics of the capacitor.

The inner electrode layers preferably have a thickness of, for example, about 0.2 μm or more and about 2.0 μm or less. The total number of the first inner electrode layers 32 and the second inner electrode layers 33 is, for example, preferably 15 or more and 2,000 or less.

The terminal electrodes will be described below. The terminal electrodes include the first terminal electrode 20 and the second terminal electrode 21. The first terminal electrode 20 is connected to the first inner electrode layers 32. The second terminal electrode 21 is connected to the second inner electrode layers 33.

The first terminal electrode 20 is disposed on the first end surface 7, a portion of the first main surface 3, a portion of the second main surface 4, a portion of the first side surface 5, and a portion of the second side surface 6. The second terminal electrode 21 is disposed on the second end surface 8, a portion of the first main surface 3, a portion of the second main surface 4, a portion of the first side surface 5, and a portion of the second side surface 6.

Each terminal electrode includes an outer electrode film 22, a nickel plating film 24, and a tin plating film 25. The outer electrode film 22, the nickel plating film 24, and the tin plating film 25 are disposed in this order from each end surface of the ceramic body 2.

The outer electrode film 22 is disposed on one end surface of the ceramic body 2 to cover the end surface. The outer electrode film 22 extends from one end surface to a portion of the main surfaces and a portion of the side surfaces.

The outer electrode film 22 includes a glass and a metal. For example, the glass includes boron and silicon and also includes barium or strontium. The glass may include at least one of, for example, calcium, magnesium, aluminum, lithium, or the like. The glass will be described below in more detail. The metal includes, for example, at least one of copper, nickel, silver, palladium, a silver-palladium alloy, gold, and the like. The outer electrode film 22 is formed by applying a conductive paste including the glass and the metal to the ceramic body 2 and firing the conductive paste. The outer electrode film 22 preferably has a thickness of, for example, about 3 μm or more and about 100 μm or less.

The nickel plating film 24 covers the outer electrode film 22.

The tin plating film 25 covers the nickel plating film 24.

The nickel plating film 24 can reduce or prevent the outer electrode film 22 from being eroded by solder for mounting the multilayer ceramic capacitor 1. The tin plating film 25 can improve solder wettability during the mounting of the multilayer ceramic capacitor 1 and can facilitate the mounting process.

The multilayer ceramic capacitor 1 may have any size. The multilayer ceramic capacitor 1 including the ceramic body 2 and the terminal electrodes preferably has a dimension of, for example, about 0.2 mm or more and about 10 mm or less in the length direction. The multilayer ceramic capacitor 1 including the ceramic body 2 and the terminal electrodes preferably has a dimension of, for example, about 0.1 mm or more and about 5 mm or less in the height direction. The multilayer ceramic capacitor 1 including the ceramic body 2 and the terminal electrodes preferably has a dimension of, for example, about 0.1 mm or more and about 10 mm or less in the width direction.

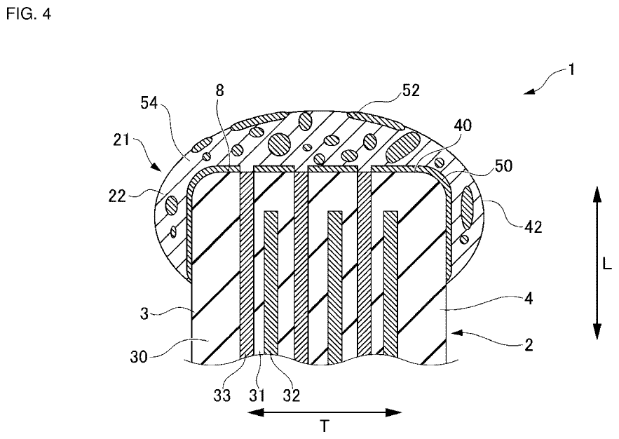

The terminal electrodes will be described in more detail with reference to FIG. 4. FIG. 4 is the LT cross-sectional view of the second end surface 8 and the surrounding area of the multilayer ceramic capacitor 1. In FIG. 4, the outer electrode film 22 included in the second terminal electrode 21 is illustrated. In FIG. 4, the nickel plating film 24 and the tin plating film 25 are not illustrated.

The conductive paste used to form the outer electrode film 22 includes, for example, a bismuth-based glass and at least one of a barium-boron-silicon-based glass, a strontium-boron-silicon-based glass, or a barium-strontium-boron-silicon-based glass. Bismuth-based glass refers to a glass that includes bismuth trioxide.

A section of glass in the outer electrode film 22 is defined as a glass domain. Of glass domains, a glass domain exposed on a surface 42 of the outer electrode film 22 but not exposed on an interface 40 of the outer electrode film 22 with the ceramic body 2 is defined as a first glass domain 52.

Of glass domains, a glass domain not exposed on the surface 42 of the outer electrode film 22 but exposed on the interface 8 of the outer electrode film 22 with the ceramic body 2 is defined as a second glass domain 50.

The concentration ratio of bismuth to silicon is higher in a portion of the first glass domain 52 that is exposed on the surface 42 of the outer electrode film 22 than in a portion of the second glass domain 50 that is exposed on the interface 8 of the outer electrode film 22 with the ceramic body 2.

In the multilayer ceramic capacitor 1 of the present example embodiment, the terminal electrodes has moisture resistance while maintaining good adhesion to the ceramic body 2 when the concentration ratio of bismuth to silicon is higher in a portion of the first glass domain 52 that is exposed on the surface 42 of the outer electrode film 22 than in a portion of the second glass domain 50 that is exposed on the interface 8 of the outer electrode film 22 with the ceramic body 2. The mechanism for this will be described below step by step.

The functions required for the glass included in the outer electrode film 22 include defining and functioning as a binder between the ceramic body 2 and the outer electrode film 22 and as a sintering aid to densify the outer electrode film 22. In particular, for film densification, the glass included in the outer electrode film 22 is required to have a low softening point.

In the related art, one type of glass, such as barium-boron-silicon-based glass, has been used. Increasing the barium ratio can lower the softening point and also makes it difficult to form a reaction layer at the interface with the ceramic body. It is therefore possible to form a preferred interface of the outer electrode film with the ceramic body without lowering the bonding strength of the adhesion interface.

Barium-boron-silicon-based glass, however, has low moisture resistance. As a result, the multilayer ceramic capacitor 1 tends to have low reliability.

Using a bismuth-based glass can be considered as an alternative method to lower the softening point of glass. Some bismuth-based glasses have compositions that have high moisture resistance.

Using a bismuth-based glass, however, may cause the sintering of the outer electrode film 22 to proceed excessively at a low temperature. As a result, the degreaseability of the outer electrode film 22 may deteriorate, and blistering may occur in the outer electrode film 22. In addition, using a bismuth-based glass results in poorer wettability on the ceramic body and weaker adhesion strength to the ceramic body than using a barium-boron-silicon-based glass.

### First Example Embodiment

In the multilayer ceramic capacitor 1 of the present example embodiment, the conductive paste used for the outer electrode film 22 includes, for example, a barium-boron-silicon-based glass and a bismuth-based glass. These glasses are distributed differently in the outer electrode film 22. The barium-boron-silicon-based glass is predominantly distributed near the ceramic body 2. The bismuth-based glass is predominantly distributed in the outer electrode film 22 near the nickel plating film 24, i.e., near the surface 42. This is because the barium-boron-silicon-based glass differs from the bismuth-based glass in wettability on the ceramic body 2. Because of the difference in wettability, the distribution of the barium-boron-silicon-based glass and the bismuth-based glass in the outer electrode film 22 changes during firing.

The concentration ratio of bismuth to silicon in a portion of the first glass domain 52 that is exposed on the surface 42 of the outer electrode film 22 is, for example, preferably at least about 1.8 times higher than the concentration ratio of bismuth to silicon in a portion of the second glass domain 50 that is exposed on the interface 8 of the outer electrode film 22 with the ceramic body 2.

When the outer electrode film 22 includes the first glass domain 52 and the second glass domain 50, the glass domains can be assigned their respective functions, such as a function as an adhesion layer and a function as a moisture resistant layer. The first glass domain 52 defines and functions as a moisture resistant layer. The second glass domain 50 defines and functions as an adhesion layer. When the first glass domain 52 and the second glass domain 50 are assigned their respective functions, the outer electrode film 22 can provide moisture resistance while maintaining good adhesion to the ceramic body 2.

Specifically, the first glass domain 52 improves the moisture resistance near the surface 42 of the outer electrode film 22. As a result, water can be prevented from penetrating into the outer electrode film 22 during immersion in a plating solution. Having moisture resistance, the outer electrode film 22 can improve the moisture reliability of the multilayer ceramic capacitor 1.

The bismuth-based glass has a low softening point. A small amount of the bismuth-based glass added, however, does not cause excessive sintering at low temperatures and thus has no adverse effect on degreaseability.

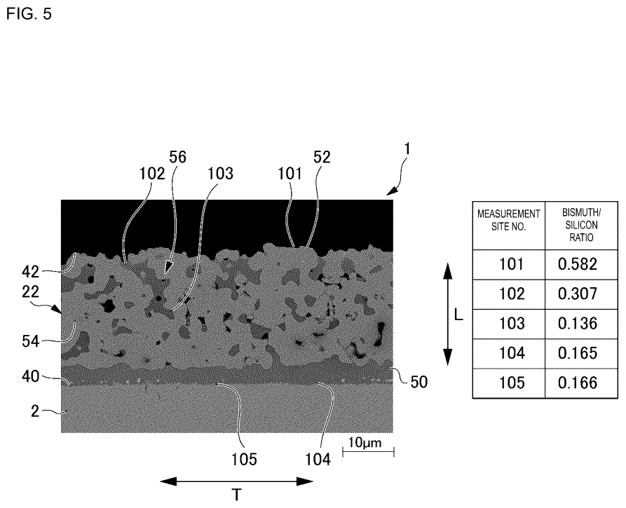

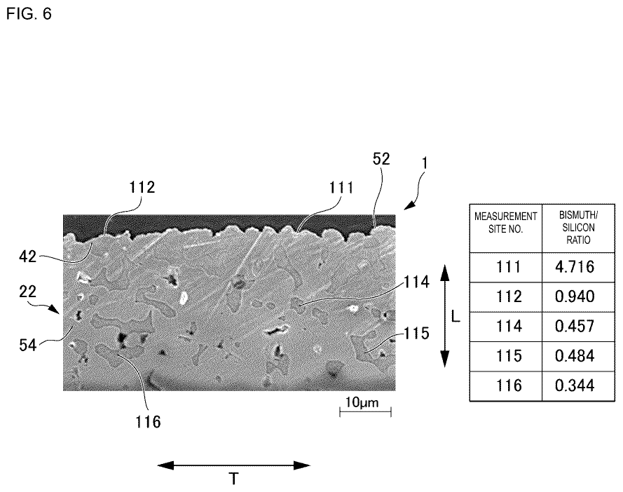

FIGS. 5 and 6 are scanning electron microscope images of the outer electrode film 22 of the multilayer ceramic capacitor 1 of the present example embodiment. The bismuth/silicon ratio in FIGS. 5 and 6 indicates the concentration ratio of bismuth to silicon in the glass.

In FIG. 5, the bismuth/silicon ratios at measurement site numbers 101 and 102 indicate the bismuth/silicon ratios in portions of the first glass domain 52 that are exposed on the surface 42 of the outer electrode film 22.

The bismuth/silicon ratios at measurement site numbers 104 and 105 indicate the bismuth/silicon ratios in portions of the second glass domain 50 that are exposed on the interface 8 of the outer electrode film 22 with the ceramic body 2.

Referring to FIG. 5, the bismuth/silicon ratios are higher in a portion of the first glass domain 52 that is exposed on the surface 42 of the outer electrode film 22 than in portions of the second glass domain 50 that are exposed on the interface 8 of the outer electrode film 22 with the ceramic body 2.

Some glass domains are elongated in the length direction L, as indicated by an arrow 56 in FIG. 5.

The concentration ratio of bismuth to silicon in the glass domain 56 is higher in a portion of the glass domain 56 that is closer to the surface 42 of the outer electrode film 22 than in a portion of the glass domain 56 that is closer to the interface 40 of the outer electrode film 22 with the ceramic body 2. In the example illustrated in FIG. 5, the bismuth/silicon ratio in the glass domain 56 is higher at the measurement site 102 than at the measurement site 103.

The example illustrated in FIG. 6 differs from the example illustrated in FIG. 5 in the composition of the barium-boron-silicon-based glass. FIG. 6 mainly illustrates the first glass domain 52.

In FIG. 6, the bismuth/silicon ratios at measurement site numbers 111 and 112 indicate the bismuth/silicon ratios in portions of the first glass domain 52 that are exposed on the surface 42 of the outer electrode film 22. The bismuth/silicon ratios at measurement site numbers 114 to 116 indicate the bismuth/silicon ratios at positions approaching the interface 40 of the outer electrode film 22 with the ceramic body 2 from the surface 42 of the outer electrode film 22.

Referring to FIG. 6, the bismuth/silicon ratio decreases as the measurement site approaches the interface 40 of the outer electrode film 22 with the ceramic body 2 from the surface 42 of the outer electrode film 22.

TABLE 1

| | Comparative | Example | Example | Example | Example | Example | Comparative | Comparative |
|---|---|---|---|---|---|---|---|---|
| Sample | Example 1 | 1 | 2 | 3 | 4 | 5 | Example 2 | Example 3 |
| Vol % of | 0 | 5 | 10 | 20 | 30 | 35 | 40 | 50 |
| bismuth- | | | | | | | | |
| based | | | | | | | | |
| glass/(barium- | | | | | | | | |
| boron-silicon- | | | | | | | | |
| based glass + | | | | | | | | |
| bismuth- | | | | | | | | |
| based glass) | | | | | | | | |
| Adhesion | A | A | A | A | A | A | A | C |
| performance | | | | | | | | |
| Blistering | A | A | A | A | A | A | C | C |
| Moisture | C | A | A | A | A | A | C | C |
| resistance | | | | | | | (blister | (blister |
| test | | | | | | | defects) | defects) |
| Overall | B | A | A | A | A | A | C | C |

The characteristics of samples with different bismuth-based glass contents are described based on Table 1. In the samples shown in Table 1, for example, the metal powder is made of copper. The metal powder has a spherical shape. The metal powder has a particle size of about 1.6 μm, for example.

The dimension of the multilayer ceramic capacitor 1 used as a sample is, for example, about 1.0 mm in the length direction L. The dimensions in the length direction L of the multilayer ceramic capacitor 1 used as a sample are, for example, about 0.5 mm in the width direction W and the height direction T.

The preparation of the samples will be described. A paste for the outer electrode film is prepared by kneading and dispersing a metal powder, a barium-boron-silicon-based glass, a bismuth-based glass, a binder resin, and a solvent.

The paste for the outer electrode film is applied to the ceramic body 2. The paste for the outer electrode film is applied by dipping. The applied paste for the outer electrode film is fired in a temperature range from about 700° C. to about 900° C., for example.

The evaluation of the film structure based on the scanning electron microscope images described above or other methods was performed by embedding each sample in a resin and polishing and sectioning the resin-embedded sample, followed by energy-dispersive X-ray spectroscopy.

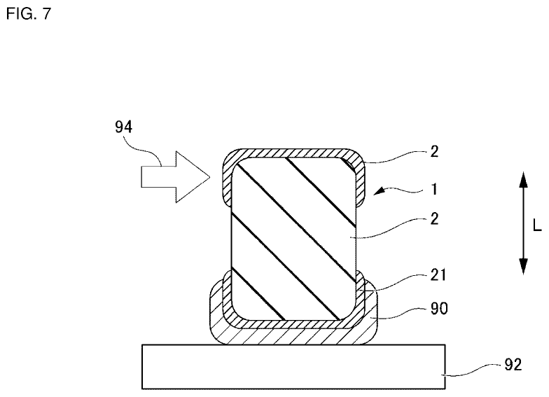

The evaluation of the adhesion performance is based on the adhesion performance of the terminal electrodes on the ceramic body 2. The evaluation of the adhesion performance will be described with reference to FIG. 7. FIG. 7 illustrates a method for evaluating adhesion performance. The multilayer ceramic capacitor 1 with, for example, the outer electrode film 22 plated with tin is used as a sample for evaluation. As illustrated in FIG. 7, the multilayer ceramic capacitor 1 is placed on a substrate 92 with the ceramic body 2 standing upright. Solder 90 is applied to the second terminal electrode 21, which is the terminal electrode near the substrate 92. This affixes the multilayer ceramic capacitor 1 onto the substrate 92. With the multilayer ceramic capacitor 1 affixed on the substrate 92, the first terminal electrode 20, which was the terminal electrode spaced away from the substrate 92, was pressed in the direction indicated by an arrow 94, i.e., the direction parallel or substantially parallel to the surface of the substrate 92.

The destruction mode caused by this lateral pressing was classified into four types:
(1) delamination at the interface between the substrate 92 and the solder 90;
(2) delamination at the interface between the solder 90 and the tin plating film in the second terminal electrode 21;
(3) delamination at the interface between the second terminal electrode 21 and the ceramic body 2; and
(4) cracks in the ceramic body 2.

The number of samples was 10. If the destruction mode (3) occurred in at least one of the 10 samples, the capacitor was rated poor and marked with “C” in Table 1.

The end surface portions of the capacitor after outer electrode formation were visually observed with an optical microscope to evaluate blistering. The thickness of the outer electrode film 22 after firing was about 30 μm. One hundred samples were observed. If at least one of the 100 samples underwent blistering, the capacitor was rated poor “C”; and if no sample underwent blistering, the capacitor was rated good “A”.

The moisture resistance test was performed using the above samples in which the nickel plating film was formed between the outer electrode film and the tin plating film. The moisture resistance test was conducted under the following conditions: a temperature of about 125° C., a humidity of about 95% RH, and an applied voltage of about 3.2 V. In the moisture resistance test, the logarithmic value log IR of the insulation resistance of the multilayer ceramic capacitor 1 was measured. If the measured log IR of at least one of 20 samples dropped by two or more digits from the initial value before about 24 hours had elapsed, the capacitor was rated poor “C”. If the log IR did not drop for all of the samples, the capacitor was rated good “A”.

As shown above in Table 1, the samples in which bismuth-based glass/(barium-boron-silicon-based glass +bismuth-based glass) was from about 5% to about 35% in terms of volume percentage were rated “A” for all of adhesion performance, blistering, and moisture resistance test, and were given an overall evaluation of “A”. In Comparative Examples 1 to 3, the samples were rated “C” for at least one of the items and were not given an overall evaluation of “A”.

An example of a method for measuring the length, thickness, and other properties of each portion will be described below. The multilayer ceramic capacitor 1 is polished to a center position in the width direction W. The LT cross-section exposed by polishing is then observed with an optical microscope or other devices. The length, thickness, and other properties can be measured from the observed LT cross-section.

An example of a method for manufacturing the multilayer ceramic capacitor 1 will be described below. First, dielectric sheets and a conductive paste for the inner electrode layers are prepared. The dielectric sheets and the conductive paste for the inner electrode layers include a binder and a solvent. The binder and the solvent may be, for example, any known organic binder and organic solvent.

The conductive paste for the inner electrode layers is applied in a predetermined pattern onto the dielectric sheets. The application of the conductive paste forms an inner electrode layer pattern. The conductive paste can be applied by, for example, screen printing, gravure printing, or other printing methods.

A predetermined number of dielectric sheets for the outer layer portion are stacked on top of one another. The inner electrode layer pattern is not printed on the dielectric sheets for the outer layer portion. On the stacked dielectric sheets, the dielectric sheets with the inner electrode layer pattern printed thereon are stacked sequentially. On top of that, a predetermined number of the dielectric sheets for the outer layer portion are further stacked. A multilayer sheet is produced through this stacking process.

The multilayer sheet is pressed in the height direction to produce a multilayer block. The pressing method may involve, for example, an isostatic press.

The multilayer block is cut into a predetermined size. A multilayer chip is cut out through this cutting process. In the cutting process, the corners and edges of the multilayer chip may be rounded. The corners and edges can be rounded by barrel polishing, for example.

The multilayer chip is fired. This firing process produces a ceramic body. The firing temperature is, for example. preferably about 900° C. or higher and about 1110° C. or lower. The firing temperature can be changed according to the materials of the dielectric layers and the inner electrode layers.

The terminal electrodes are formed. First, a conductive paste, which will define and function as the outer electrode film 22, is applied to two end surfaces of the ceramic body 2. The conductive paste includes, for example, a glass and a metal. The conductive paste can be applied by, for example, dipping or other methods. After the application, the conductive paste is fired to form the outer electrode film 22. The firing temperature is, for example, preferably about 500° C. or higher and about 900° C. or lower. The firing time is, for example, preferably about 30 minutes or longer and about 2 hours or shorter.

The nickel plating film 24 is formed on each of the surfaces of the outer electrode films 22. The tin plating film 25 is further formed on each of the surfaces of the nickel plating films 24. The nickel plating films 24 and the tin plating films 25 can be formed by, for example, barrel plating or other methods. The multilayer ceramic capacitor 1 is produced accordingly.

### Other Example Embodiments

In the example embodiment described above, the conductive paste used to form the outer electrode films includes, for example, a barium-boron-silicon-based glass and a bismuth-based glass, but the conductive paste is not limited to this composition. The conductive paste may include, for example, a strontium-boron-silicon-based glass or a barium-strontium-boron-silicon-based glass, instead of the barium-boron-silicon-based glass.

The use of the glasses in other example embodiments also provides the same or substantially the same advantageous effects as in the first example embodiment. Specifically, when a glass domain exposed on the surface of an outer electrode film but not exposed on the interface of the outer electrode film with the ceramic body was defined as a first glass domain, and a glass domain not exposed on the surface of the outer electrode film but exposed on the interface of the outer electrode film with the ceramic body was defined as a second glass domain, the bismuth/silicon ratio was larger in a portion of the first glass domain that was exposed on the surface of the outer electrode film than in a portion of the second glass domain 50 that was exposed on the interface of the outer electrode film with the ceramic body. The moisture resistance test conducted under the same or substantially the same conditions as in the first example embodiment reveals that the samples that satisfy the above relationship of the bismuth/silicon ratio have good moisture resistance.

Although the example embodiments of the present invention are described above, the present invention is not limited to the above example embodiments, and various changes and variations are possible.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a ceramic body including a plurality of stacked dielectric layers, a plurality of stacked inner electrode layers, a first main surface and a second main surface facing each other in a height direction, a first side surface and a second side surface facing each other in a width direction perpendicular or substantially perpendicular to the height direction, and a first end surface and a second end surface facing each other in a length direction perpendicular or substantially perpendicular to the height direction and the width direction; and
a terminal electrode on the ceramic body and connected to some of the plurality of inner electrode layers; wherein
the terminal electrode includes an outer electrode film in contact with the ceramic body;
the outer electrode film includes at least a first glass including at least one of a barium-boron-silicon-based glass, a strontium-boron-silicon-based glass, or a barium-strontium-boron-silicon-based glass, and a second glass including a bismuth-based glass;
the first glass and the second glass define glass domains in the outer electrode film; and
when, of the glass domains, a glass domain exposed on a surface of the outer electrode film but not exposed on an interface of the outer electrode film with the ceramic body is defined as a first glass domain, and a glass domain not exposed on the surface of the outer electrode film but exposed on the interface of the outer electrode film with the ceramic body is defined as a second glass domain, a concentration ratio of bismuth to silicon is higher in a portion of the first glass domain that is exposed on the surface of the outer electrode film than in a portion of the second glass domain that is exposed on the interface of the outer electrode film with the ceramic body.

2. The multilayer ceramic capacitor according to claim 1, wherein the concentration ratio of bismuth to silicon in the glass domains is higher in portions of the glass domains that are closer to the surface of the outer electrode film than in portions of the glass domains that are closer to the interface of the outer electrode film with the ceramic body.

3. The multilayer ceramic capacitor according to claim 1, wherein a total number of the plurality of dielectric layers is 15 or more and 2000 or less.

4. The multilayer ceramic capacitor according to claim 1, wherein each of the plurality of dielectric layers includes barium titanate, calcium titanate, strontium titanate, or calcium zirconate as a main component.

5. The multilayer ceramic capacitor according to claim 4, wherein each of the plurality of dielectric layers includes a manganese compound, an iron compound, a chromium compound, a cobalt compound, or a nickel compound as a secondary component.

6. The multilayer ceramic capacitor according to claim 1, wherein a thickness of each of the plurality of dielectric layers is about 0.3 μm or more and about 10 μm or less.

7. The multilayer ceramic capacitor according to claim 1, wherein
a dimension of the ceramic body in the length direction is about 0.2 mm or more and about 10 mm or less;
a dimension of the ceramic body in the width direction is about 0.1 mm or more and about 5 mm or less; and
a dimension of the ceramic body in the height direction is about 0.1 mm or more and about 5 mm or less.

8. The multilayer ceramic capacitor according to claim 1, wherein each of the plurality of inner electrode layers includes nickel, copper, silver, palladium, or gold, or an alloy including at least one of nickel, copper, silver, palladium, or gold.

9. The multilayer ceramic capacitor according to claim 1, wherein a thickness of each of the plurality of inner electrode layers is about 0.2 μm or more and about 2.0 μm or less.

10. The multilayer ceramic capacitor according to claim 1, wherein a total number of the plurality of inner electrode layers is 15 or more and 2000 or less.

11. The multilayer ceramic capacitor according to claim 1, wherein the terminal electrode includes a nickel plating film covering the outer electrode film, and a tin plating film covering the nickel plating film.

12. The multilayer ceramic capacitor according to claim 1, wherein the outer electrode film includes the barium-boron-silicon-based glass and the bismuth-based glass.

13. The multilayer ceramic capacitor according to claim 1, wherein the concentration ratio of bismuth to silicon is at least about 1.8 times higher in the portion of the first glass domain that is exposed on the surface of the outer electrode film than in the portion of the second glass domain that is exposed on the interface of the outer electrode film with the ceramic body.

14. A paste for a terminal electrode of a multilayer ceramic capacitor, the paste comprising:
at least a first glass including at least one of a barium-boron-silicon-based glass, a strontium-boron-silicon-based glass, or a barium-strontium-boron-silicon-based glass, and a second glass including a bismuth-based glass.

15. The paste according to claim 14, wherein the first glass includes a barium-boron-silicon-based glass.
